(19) United States
(12) Patent Application Publication
(10) Pub. No.: US 2026/0043984 A1
(43) Pub. Date: Feb. 12, 2026

(54) LENS STRUCTURE

(71) Applicant: Asia Optical Co., Inc., Taichung (TW)

(72) Inventors: Keng-Hui Lin, Taichung (TW); Chiao-Sen Hsu, Taichung (TW); Cheng-Ren Yu, Taichung (TW); Tsi-Lung Wu, Taichung (TW)

(21) Appl. No.: 19/014,569

(22) Filed: Jan. 9, 2025

(30) Foreign Application Priority Data
Aug. 12, 2024 (TW) 113130161

(51) Int. Cl. G02B 7/02

(52) U.S. Cl. CPC G02B 7/021; G02B 7/025

(57) ABSTRACT

A lens structure includes a first lens, a second lens and a first spacer. The first lens includes a first surface, a second surface opposite to the first surface and a first outer circumferential surface connecting the first surface and the second surface. The second lens includes a third surface, a fourth surface opposite to the third surface and a second outer circumferential surface connecting the third surface and the fourth surface. The first spacer is annular and includes a first end surface and a second end surface. The first end surface is connected to the first surface, and the second end surface is connected to the second surface, whereby the first lens is connected to the second lens through the first spacer.

### BACKGROUND OF THE INVENTION

### Field of the Invention

The invention relates to a technical field of lens structure, and more particularly to a lens structure without any lens barrel.

### Description of the Related Art

An existing lens structure generally has multiple lenses installed in a lens barrel. The structure of the lens barrel limits the installation position of each lens so that the optical axes of the lenses can be arranged in alignment.

Lens barrels are generally manufactured by using a plastic injection molding process, thereby requiring molds for plastic injection molding. That increases the cost of lens production. Further, every lens barrel is different in dimension. However, high precision of the lens structure is required. Therefore, the yield of the lens structure will be significantly affected by the micro interference between the lens barrel and the lenses and the thermal expansion and contraction of the lens barrel. The thickness of the lens barrel is also limited by the internal space of an optical system. Thinner lens barrels or uneven lens barrel thicknesses will affect the accuracy of lens assembly. The manufacturing tolerances of each components of the lens structure and the assembly tolerances of each components will lead to a reduction in the yield of high-precision lens structures. Further, because of the thickness and weight of the lens barrel, reduction of the weight and size of the overall lens structure is challenge.

### BRIEF SUMMARY OF THE INVENTION

The invention provides a lens structure in which no lens barrel is provided and the lenses (or lenses and spacers) are directly assembled. By such arrangement, the tolerances of manufacturing the lens barrel and assembling the lens barrel and the lens can be avoided, the problem of the prior art that the yield of the lens structure cannot be improved due to the installation of the lens barrel can be solved, and the weight and size of the overall lens structure can be reduced.

The lens structure in accordance with an exemplary embodiment of the invention includes an optical axis, a perpendicular axial direction, at least two lenses and at least one spacer. A light beam enters or exits from the lens structure along the optical axis. The perpendicular axial direction is perpendicular to the optical axis. The at least two lenses includes a first lens and a second lens. The first lens includes a first surface, a second surface disposed opposite to the first surface, and a first outer circumferential surface disposed between the first surface and the second surface. The second lens includes a third surface, a fourth surface disposed opposite to the third surface, and a second outer circumferential surface disposed between the third surface and the fourth surface. The at least one spacer includes a first spacer which includes a first end surface, a second end surface disposed opposite to the first end surface, and a first outer annular surface disposed between the first end surface and the second end surface. The first end surface is connected to the second surface and the second end surface is connected to the third surface so that the first lens is connected to the second lens through the first spacer along the optical axis. The first outer circumferential surface, the second outer circumferential surface and the first outer annular surface are parallel to the optical axis. A projected area of the first outer annular surface projected onto the first outer circumferential surface in the perpendicular axial direction is 0%-50% of a total area of the first outer circumferential surface, which means that the 0%-50% area of the first outer circumferential surface of the first lens is overlapped by the first outer annular surface of the first spacer at the perpendicular axial direction. And/or a projected area of the first outer annular surface projected onto the second outer circumferential surface in the perpendicular axial direction is 0%-50% of a total area of the second outer circumferential surface, which means that the 0%-50% area of the second outer circumferential surface of the second lens is overlapped by the first outer annular surface of the first spacer at the perpendicular axial direction.

In another exemplary embodiment, the lens structure includes an optical axis, a perpendicular axial direction, at least two lenses and at least one spacer. A light beam enters or exits from the lens structure along the optical axis. The perpendicular axial direction is perpendicular to the optical axis. The at least two lenses includes a first lens and a second lens. The first lens includes a first surface, a second surface disposed opposite to the first surface, and a first outer circumferential surface disposed between the first surface and the second surface. The second lens includes a third surface, a fourth surface disposed opposite to the third surface, and a second outer circumferential surface disposed between the third surface and the fourth surface. The at least one spacer includes a first spacer which includes a first end surface, a second end surface disposed opposite to the first end surface, and a first outer annular surface disposed between the first end surface and the second end surface. The first end surface is connected to the second surface and the second end surface is connected to the third surface so that the first lens is connected to the second lens through the first spacer along the optical axis. The first outer circumferential surface, the second outer circumferential surface and the first outer annular surface are parallel to the optical axis. The second surface has a first radius of curvature at the optical axis, the third surface has a second radius of curvature at the optical axis, and the first radius of curvature is not equal to the second radius of curvature.

In yet another exemplary embodiment, the lens structure includes an optical axis, a perpendicular axial direction, at least three lenses and at least two spacers. A light beam enters or exits from the lens structure along the optical axis. The perpendicular axial direction is perpendicular to the optical axis. The at least three lenses include a first lens, a second lens, and a third lens. The at least two spacers include a first spacer and a second spacer. The first lens includes a first surface, a second surface disposed opposite to the first surface, and a first outer circumferential surface disposed between the first surface and the second surface. The second lens includes a third surface, a fourth surface disposed opposite to the third surface, and a second outer circumferential surface disposed between the third surface and the fourth surface. The third lens includes a fifth surface, a sixth surface disposed opposite to the fifth surface, and a third outer circumferential surface disposed between the fifth surface and the sixth surface. The first spacer includes a first end surface, a second end surface disposed opposite to the first end surface, and a first outer annular surface disposed between the first end surface and the second end surface. The second spacer includes a third end surface, a fourth end surface disposed opposite to the third end surface, and a second outer annular surface disposed between the third end surface and the fourth end surface. The first end surface and the second surface have no air gap therebetween, the second end surface and the third surface have no air gap therebetween, the third end surface and the fourth surface have no air gap therebetween, and the fourth end surface and the fifth surface have no air gap therebetween, so that the first lens is connected to the second lens through the first spacer along the optical axis and the second lens is connected to the third lens through the second spacer along the optical axis. The first outer circumferential surface, the second outer circumferential surface, the third outer circumferential surface, the first outer annular surface and the second outer circumferential surface are parallel to the optical axis. The first outer circumferential surface, the second outer circumferential surface, the third outer circumferential surface, the first outer annular surface and the second outer annular surface have a side disposed distant from the optical axis. The first lens, the second lens, the third lens, the first spacer and the second spacer are not covered by a lens barrel at the side, are exposed to an exterior of the lens structure at the side, are directly in contact with air at the side, or are not covered by plastic material or metal material at the side.

In another exemplary embodiment, the first spacer further includes a first inner annular surface and at least one through hole, the first inner annular surface and the first outer annular surface are disposed opposite to each other, the first inner annular surface is disposed between the first end surface and the second end surface and is disposed closer to the optical axis than the first outer annular surface, and the at least one through hole is extended from the first outer annular surface to the first inner annular surface.

In yet another exemplary embodiment, the first end surface and the second surface have no air gap therebetween. The second end surface and the third surface have no air gap therebetween. The first outer circumferential surface, the second outer circumferential surface and the first outer annular surface have a side disposed distant from the optical axis. The first lens, the second lens and the first spacer are exposed to an exterior of the lens structure at the side without being covered by a lens barrel.

In another exemplary embodiment, the first lens or the second lens is circular, oval, rectangular, or polygonal, or has a D-cut shape or an H-cut shape.

In yet another exemplary embodiment, the lens structure further includes a third lens, a fourth lens and a third spacer. The third lens includes a fifth surface, a sixth surface disposed opposite to the fifth surface, and a third outer circumferential surface disposed between the fifth surface and the sixth surface. The fourth lens includes a seventh surface, an eighth surface disposed opposite to the seventh surface, and a fourth outer circumferential surface disposed between the seventh surface and the eighth surface. The third spacer includes a fifth end surface, a sixth end surface disposed opposite to the fifth end surface, and a third outer annular surface disposed between the fifth end surface and the sixth end surface. The fourth surface is connected to the sixth surface, the fifth end surface and the sixth surface have no air gap therebetween, and the sixth end surface and the seventh surface have no air gap therebetween, so that the third lens is connected to the fourth lens through the third spacer along the optical axis. The third outer circumferential surface, the fourth outer circumferential surface and the third outer annular surface are parallel to the optical axis. The third outer circumferential surface, the fourth outer circumferential surface and the third outer annular surface have a side disposed distant from the optical axis. The third lens, the fourth lens and the third spacer are exposed to an exterior of the lens structure at the side without being covered by a lens barrel. The second outer circumferential surface and the third outer circumferential surface are not overlapped in the perpendicular axial direction.

In another exemplary embodiment, the second surface has a first radius of curvature near the optical axis, the third surface has a second radius of curvature near the optical axis, and the first radius of curvature is not equal to the second radius of curvature.

In yet another exemplary embodiment, the lens structure satisfies at least one of the following conditions:

$$0.07 ≦ OT / IT ≦ 50 ,$$

$$2.9 mm ≦ ( OT \times LD ) / ID ≦ 100 mm ,$$

$$20 \% ≦ {C}_{cover} / {C}_{totC 1} ≦ 100 \% , and$$

$$50 \% ≦ {C}_{expose} / {C}_{totC 2} ≦ 100 \% ,$$

where OT is a thickness of any one of the lenses, IT is a thickness of any one of the spacers, LD is a diameter of any one of the lenses, ID is a minimum sidewall thickness of any one of the spacers, C_{cover} is an area of a joining surface of any one of the spacers covered by a joining portion of an adjacent lens in an optical axial direction, C_{totC1} is a total area of the joining surface of the spacer, Cₑₓₚₒₛₑ is an area of an outer circumferential surface of any one of the lenses that is exposed without being covered in the perpendicular axial direction, and C_{totC2} is a total area of the outer circumferential surface of the lens.

In another exemplary embodiment, the first spacer further includes at least one chamfer and at least one through hole disposed on the first outer annular surface, the first lens further includes a flange structure and a light transmitting portion, the light transmitting portion is radially extended to form the flange structure, and the flange structure is configured to bear the first spacer.

In yet another exemplary embodiment, a surface of any one of the at least two lenses of the lens structure and an end surface of an adjacent spacer corresponding to the surface of any one of the at least two lenses are bonded, glued or fused to each other.

In a the lens structure of any one of the above-mentioned embodiments of the invention, a surface of any one of the lenses and an end surface of an adjacent spacer corresponding to the surface of any one of the lenses are bonded to each other by traditional UV light curing, are glued to each other by applying viscous material glue or by heat curing, or are fused to each other by laser welding process, so that the lenses and the adjacent spacers are connected. The connection of a first lens, a second lens and a first spacer is taken as an example. A first end surface of the first spacer is bonded, glued, or fused to a second surface of the first lens, and a second end surface of the first spacer is bonded, glued, or fused to a third surface of the second lens, so that the first lens is connected to the second lens through the first spacer. Accordingly, a lens structure without any lens barrel can be obtained. The problem of the prior art that the yield of product is reduced due to the superposition of tolerances caused by installation of the lens barrel can be avoided.

### BRIEF DESCRIPTION OF THE DRAWINGS

FIG. 1 is a sectional view of a lens structure in accordance with a first embodiment of the invention.

FIG. 2 is a sectional view of a lens structure in accordance with a second embodiment of the invention.

FIG. 3 is a sectional view of a lens structure in accordance with a third embodiment of the invention.

FIG. 4 is a sectional view of a lens structure in accordance with a fourth embodiment of the invention.

FIG. 5 is a sectional view of a lens structure in accordance with a fifth embodiment of the invention.

FIG. 6 is a sectional view of a lens structure in accordance with a sixth embodiment of the invention.

FIG. 7 is a sectional view of a lens structure in accordance with a seventh embodiment of the invention.

FIG. 8 is a perspective view and an exploded perspective view of a lens structure in accordance with an eighth embodiment of the invention.

FIG. 9 is a perspective view of a lens structure in accordance with a ninth embodiment of the invention.

### DETAILED DESCRIPTION OF THE INVENTION

In the following descriptions, the axial direction is a direction that is parallel to the optical axis O of the lenses, and the radial direction is a perpendicular axial direction that is perpendicular to the optical axis of the lenses.

A lens structure of an embodiment of the invention includes at least one spacer and at least two lenses arranged along an optical axis. The at least one spacer is disposed between the at least two lenses. No air gap is provided between the at least one spacer and the at least two lenses. The outer circumference (distant from the optical axis) of the at least one spacer and the at least two lenses is not covered (is exposed to the exterior of the lens structure without any lens barrel provided thereon). This design can achieve basic operation of the invention. For example, the lenses and spacers are directly in contact with air, or are not covered by plastic material or metal material at a side that is distant from the optical axis.

A lens structure of another embodiment differs from the above-mentioned lens structure in that the at least two lenses may be biconcave lenses, biconvex lenses, meniscus lenses, plano-convex lenses, plano-concave lenses, convex-plano lenses, concave-plano lenses, convex-concave lenses or concave-convex lenses, and the surfaces of the at least two lenses that face the at least one spacer have different radii of curvature at the optical axis.

In yet another embodiment, the lens structure not only has the same structure as either of the above-mentioned embodiments but satisfies the following conditions (1), (2), (3), and (4) for increasing the structure strength and reducing the volume, wherein the condition (1) is 0.07≤OT/IT≤50, the condition (2) is 2.9 mm≤(OT×LD)/ID≤100 mm, the condition (3) is 20% C_{cover}/C_{torC1}≤100%, and the condition (4) is 50%≤Cₑₓₚₒₛₑ/C_{totC2}≤100% where OT is a thickness of any one of the lenses, IT is a thickness of any one of the spacers, LD is a diameter of any one of the lenses, ID is a minimum sidewall thickness of any one of the spacers, C_{cover} is an area of a joining surface of any one of the spacers covered by a joining portion of an adjacent lens in an optical axial direction, C_{totC1} is a total area of the joining surface of the spacer, Cₑₓₚₒₛₑ is an area of an outer circumferential surface of any one of the lenses that is exposed without being covered in the perpendicular axial direction, and C_{totC2} is a total area of the outer circumferential surface of the lens.

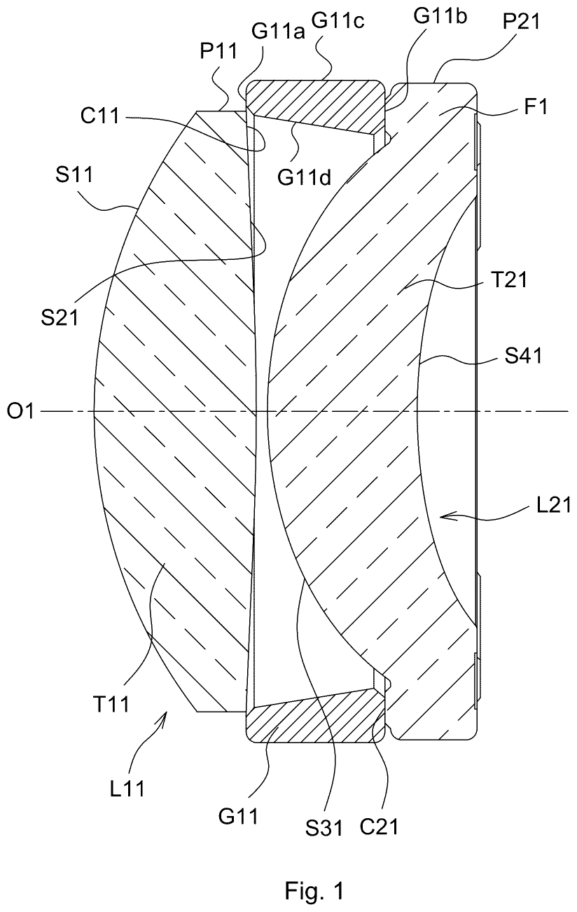

Referring to FIG. 1, a lens structure of a first embodiment of the invention includes a first lens L11, a first spacer G11 and a second lens L21 that are sequentially arranged along an optical axis O1.

In the first embodiment, the first lens L11 is a biconvex lens that includes a first surface S11, a second surface S21 disposed opposite to the first surface S11, and a first outer circumferential surface P11 disposed between the first surface S11 and the second surface S21 and parallel to the optical axis O1. The first surface S11 and the second surface S21 individually have an optical effective zone to form a first light transmitting portion T11 of the first lens L11. Further, the first surface S11 and the second surface S21 individually have a non-optical effective zone, wherein the non-optical effective zone of the second surface S21 forms a first joining portion C11 of the first lens L11.

In the first embodiment, the second lens L21 is a meniscus lens that includes a third surface S31, a fourth surface S41 disposed opposite to the third surface S31, and a second outer circumferential surface P21 disposed between the third surface S31 and the fourth surface S41 and parallel to the optical axis O1. The third surface S31 and the fourth surface S41 individually have an optical effective zone to form a second light transmitting portion T21 of the second lens L21. Further, the third surface S31 and the fourth surface S41 individually have a non-optical effective zone, wherein the non-optical effective zone of the third surface S31 forms a second joining portion C21 of the second lens L21. In the first embodiment, the second joining portion C21 is disposed on a side of a flange structure F1 that faces the first spacer G11, wherein the flange structure F1 is radially extended from the outer circumferential surface of the second light transmitting portion T21. However, the invention is not limited thereto. For example, the second joining portion may be a structure (not shown) extended away from the optical axis under the circumstance that the curvature of the second light transmitting portion is not modified.

The first spacer G11 is in a closed shape, including two joining surfaces (namely a first end surface G11a and a second end surface G11b) disposed opposite to each other, and a first outer annular surface G11c and a first inner annular surface G11d disposed between the first end surface G11a and the second end surface G11b. The first end surface G11a of the first spacer G11 is connected to the first joining portion C11 of the first lens L11, and the second end surface G11b of the first spacer G11 is connected to the second joining portion C21 of the second lens L21. By such arrangement, light passing through the first lens L11 and the second lens L21 along the optical axis O1 is not affected by the connection of the first spacer G11 to the first lens L11 and the second lens L21. The connection method may be, for example, but not limited to, curing and gluing by irradiating ultraviolet light, fusion by heating or laser welding, or adhesion with adhesive materials such as glue. Further, there is no air gap between the first end surface G11a and the second surface S21 of the first lens L11, and there is no air gap between the second end surface G11b and the third surface S31 of the second lens L21. That is, a surface of the lens (or any lenses) in the lens structure and an end surface of the adjacent spacer corresponding to the surface of the lens are bonded, glued or fused to each other. In the first embodiment, the second joining portion C21 is a flat surface that ensures the radial tilt of the second lens L21 when the second lens L21 is connected to the first spacer G11. The first outer annular surface G11c and the first inner annular surface G11d are disposed opposite to each other. The first inner annular surface G11d has a first diameter at an end near the first lens L11, and a second diameter at another end near the second lens L21. The first diameter is greater than the second diameter. Therefore, the area of the first end surface G11a is less than that of the second end surface G11b, and the first spacer G11 is a tapered sleeve with reducing inner diameter. The second end surface G11b with greater area is connected to the second joining portion C21, and the first end surface G11a with smaller area is connected to the first joining portion C11 so that the connection is stable. In some other embodiments, the inner annular surface of the first spacer may have a constant diameter, the outer annular surface may have an increasing diameter, and therefore the first spacer may be a tapered sleeve with increasing outer diameter. Alternatively, each of the outer annular surface and the inner annular surface of the first spacer may have a constant diameter, and therefore the first spacer may be a sleeve with a constant inner diameter.

According to the above connection without air gap, no lens barrel is required to be provided for the first lens L11, the second lens L21, and the first spacer G11 at a side of the first outer circumferential surface P11, the second outer circumferential surface P21 and the first outer annular surface G11c that is distant from the optical axis O1.

In the first embodiment, the first outer annular surface G11c of the first spacer G11 is slightly farther from the optical axis than the second outer circumferential surface P21 of the second lens L21. In some other embodiments, the first outer annular surface of the first spacer may be almost flushed with the optical axis than the second outer circumferential surface of the second lens. In the first embodiment, the first outer annular surface G11c of the first spacer G11 is farther from the optical axis O1 than the first outer circumferential surface P11 of the first lens L11. The first outer circumferential surface P11 is not covered with the first spacer G11, so that the ratio of the exposed area of the first outer circumferential surface P11 that is not covered in the perpendicular axial direction to the total area of the first outer circumferential surface P11 is 100%. Similarly, the second outer circumferential surface P21 is not covered with the first spacer G11, so that the ratio of the exposed area of the second outer circumferential surface P21 that is not covered in the perpendicular axial direction to the total area of the second outer circumferential surface P21 is 100%. The second surface S21 of the first lens L11 overlaps the first end surface G11a of the first spacer G11 in the optical axial direction O1, with about 20% of the first end surface G11a covered by the second surface S21 in the optical axial direction O1. That is, C_{cover}/C_{totC1} is about 20%. The third surface S31 of the second lens L21 overlaps the second end surface G11b of the first spacer G11 in the optical axial direction O1, with about 99% of the second end surface G11b covered by the third surface S31 in the optical axial direction O1. That is, C_{cover}/C_{totC1} is about 99%.

In the first embodiment, the distance between the first end surface G11a and the second end surface G11b of the first spacer G11 in the optical axial direction is defined as the spacer thickness. The spacer thickness is determined in accordance with the combination of the first lens L11 and the second lens L21 with a predetermined distance between them so that they can exhibit pre-designed optical characteristics. The lens thickness of the first lens L11 is defined as the axial distance from the first surface S11 to the second surface S21 near the optical axis. The lens thickness may be 0.1 mm, 0.4 mm, 0.6 mm, 1 mm, 2 mm or 5 mm. The ratio of the lens thickness OT of the first lens L11 to the spacer thickness IT is ranged from 0.002 to 50. The lens thickness of the second lens L21 may be the same as or different from that of the first lens L11. The ratio of the lens thickness of the second lens to the spacer thickness is also ranged from 0.002 to 50.

Table 1 shows parameters of each elements of the lens structure of the first embodiment.

TABLE 1

| Element | Radius of Curvature (mm) | Thickness (mm) |
|---|---|---|
| L11 | S11: 45 | 1.4 |
| | S21: −21.8 | |
| G11 | — | 1.3 |
| L21 | S31: 3.8 | 1.5 |
| | S41: 4.8 | |

Table 2 shows the values of parameters and the calculated values of the corresponding conditions of the lens structure of the first embodiment.

TABLE 2

| | | | |
|---|---|---|---|
| OT | 1.4, 1.5 | IT | 1.3 |
| LD | 10 | ID | 0.3 |
| OT/IT | 1.08, 1.15 | (OT × LD)/ID | 46.67, 50 |
| C_{cover}/C_{totC1} | 20%, 99% | Cₑₓₚₒₛₑ/C_{totC2} | 100% |

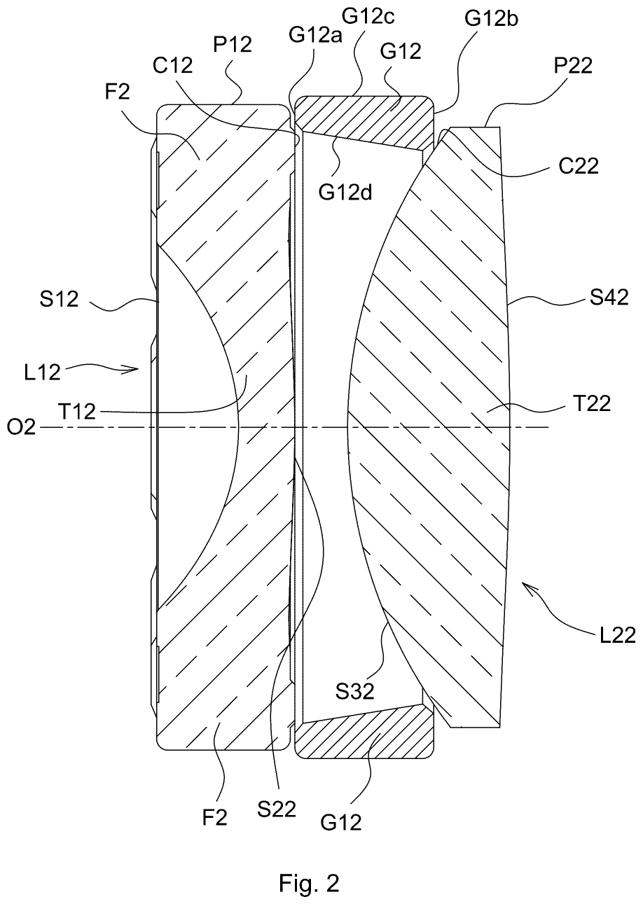

Referring to FIG. 2, a lens structure of a second embodiment of the invention includes a first lens L12, a first spacer G12 and a second lens L22 that are sequentially arranged along an optical axis O2.

In the second embodiment, the first lens L11 is a meniscus lens that includes a first surface S12, a second surface S22 disposed opposite to the first surface S12, and a first outer circumferential surface P12 disposed between the first surface S12 and the second surface S22 and parallel to the optical axis O2. The first surface S12 and the second surface S22 individually have an optical effective zone to form a first light transmitting portion T12 of the first lens L12. Further, the first surface S12 and the second surface S22 individually have a non-optical effective zone, wherein the non-optical effective zone of the second surface S22 forms a first joining portion C12 of the first lens L12. In the second embodiment, the first joining portion C12 is disposed on a side of a flange structure F2 that faces the first spacer G12, wherein the flange structure F2 is radially extended from the outer circumferential surface of the first light transmitting portion T12.

In the second embodiment, the second lens L21 is a biconvex lens that includes a third surface S32, a fourth surface S42 disposed opposite to the third surface S31, and a second outer circumferential surface P22 disposed between the third surface S32 and the fourth surface S42 and parallel to the optical axis O2. The third surface S32 and the fourth surface S42 individually have an optical effective zone to form a second light transmitting portion T22 of the second lens L22. Further, the third surface S32 and the fourth surface S42 individually have a non-optical effective zone, wherein the non-optical effective zone of the third surface S32 forms a second joining portion C22 of the second lens L22.

The first spacer G12 includes two joining surfaces (namely a first end surface G12a and a second end surface G12b) disposed opposite to each other, and a first outer annular surface G12c and a first inner annular surface G12d disposed between the first end surface G12a and the second end surface G12b. The connection of the first lens L12, the first spacer G12 and the second lens L21 of the second embodiment is the same as that of the first embodiment, and therefore the descriptions thereof are omitted. In the second embodiment, the first outer circumferential surface P12 is not covered with the first spacer G12, so that the ratio of the exposed area of the first outer circumferential surface P12 that is not covered in the perpendicular axial direction to the total area of the first outer circumferential surface P12 is 100%. Similarly, the second outer circumferential surface P22 is not covered with the first spacer G11, so that the ratio of the exposed area of the second outer circumferential surface P22 that is not covered in the perpendicular axial direction to the total area of the second outer circumferential surface P22 is 100%. The second surface S22 of the first lens L12 overlaps the first end surface G12a of the first spacer G12 in the optical axial direction O2, with about 60% of the first end surface G12a covered by the second surface S22 in the optical axial direction O2. That is, C_{cover}/C_{totC1} is about 60%. The third surface S32 of the second lens L22 overlaps the second end surface G12b of the first spacer G12 in the optical axial direction O2, with about 30% of the second end surface G12b covered by the third surface S32 in the optical axial direction O2. That is, C_{cover}/C_{totC1} is about 30%. The spacer thickness of the second embodiment is not limited to that shown in Table 2 above and can be adjusted according to the requirements, such as but not limited to 0.1 mm to 50 mm. Under the same lens conditions, different lens structures with different optical properties such as different back focal length (BFL) or different field of view (FOV) can be obtained by combining spacers of different thicknesses.

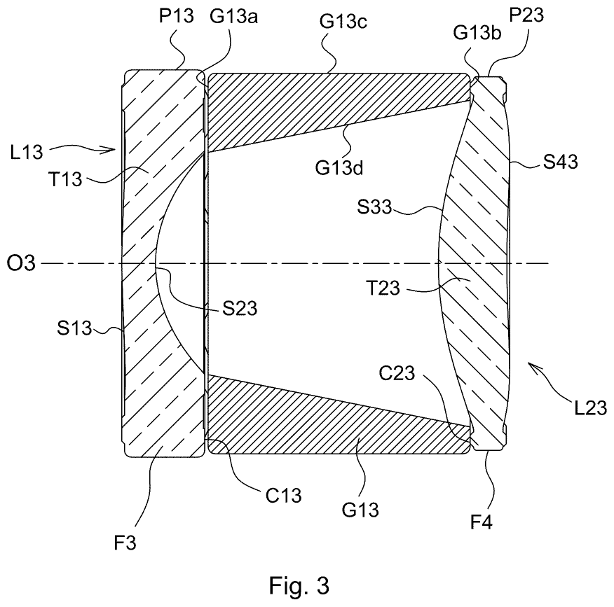

Referring to FIG. 3, a lens structure of a third embodiment of the invention includes a first lens L13, a first spacer G13 and a second lens L23 that are sequentially arranged along an optical axis O3.

In the third embodiment, the first lens L13 is a meniscus lens that includes a first surface S13, a second surface S23 disposed opposite to the first surface S13, and a first outer circumferential surface P13 disposed between the first surface S13 and the second surface S23 and parallel to the optical axis O3. The first surface S13 and the second surface S23 individually have an optical effective zone to form a first light transmitting portion T13 of the first lens L13. Further, the first surface S13 and the second surface S23 individually have a non-optical effective zone, wherein the non-optical effective zone of the second surface S23 forms a first joining portion C13 of the first lens L13. In the third embodiment, the first joining portion C13 is disposed on a side of a flange structure F3 that faces the first spacer G13, wherein the flange structure F3 is radially extended from the outer circumferential surface of the first light transmitting portion T13.

In the third embodiment, the second lens L23 is a meniscus lens that includes a third surface S33, a fourth surface S43 disposed opposite to the third surface S33, and a second outer circumferential surface P23 disposed between the third surface S33 and the fourth surface S43 and parallel to the optical axis O3. The third surface S33 and the fourth surface S43 individually have an optical effective zone to form a second light transmitting portion T23 of the second lens L23. Further, the third surface S33 and the fourth surface S43 individually have a non-optical effective zone, wherein the non-optical effective zone of the third surface S33 forms a second joining portion C23 of the second lens L23. In the third embodiment, the second joining portion C23 is disposed on a side of a flange structure F4 that faces the first spacer G13, wherein the flange structure F4 is radially extended from the outer circumferential surface of the second light transmitting portion T23.

The first spacer G13 includes two joining surfaces (namely a first end surface G13a and a second end surface G13b) disposed opposite to each other, and a first outer annular surface G13c and a first inner annular surface G13d disposed between the first end surface G13a and the second end surface G13b. The connection of the first lens L13, the first spacer G13 and the second lens L23 of the third embodiment is the same as that of the first embodiment, and therefore the descriptions thereof are omitted. The third embodiment differs from the first embodiment in that the first outer annular surface G13c of the first spacer G13 is disposed closer to the optical axis O3 than the first outer circumferential surface P13 and is disposed farther from the optical axis O3 than the second outer circumferential surface P23 of the second lens L23. In the third embodiment, the first outer circumferential surface P13 is not covered with the first spacer G13, so that the ratio of the exposed area of the first outer circumferential surface P13 that is not covered in the perpendicular axial direction to the total area of the first outer circumferential surface P13 is 100%. Similarly, the second outer circumferential surface P23 is not covered with the first spacer G13, so that the ratio of the exposed area of the second outer circumferential surface P23 that is not covered in the perpendicular axial direction to the total area of the second outer circumferential surface P23 is 100%. The second surface S23 of the first lens L13 overlaps the first end surface G13a of the first spacer G13 in the optical axial direction O3, with about 100% of the first end surface G13a covered by the second surface S23 in the optical axial direction O3. That is, C_{cover}/C_{totC1} is about 100%. The third surface S33 of the second lens L23 overlaps the second end surface G13b of the first spacer G13 in the optical axial direction O3, with about 20% of the second end surface G13b covered by the third surface S33 in the optical axial direction O3. That is, C_{cover}/C_{totC1} is about 20%.

Table 3 shows parameters of each elements of the lens structure of the third embodiment.

TABLE 3

| Element | Radius of Curvature (mm) | Thickness (mm) |
|---|---|---|
| L13 | S13: 12.6 | 1 |
| | S23: 19.3 | |
| G13 | — | 3.8 |
| L23 | S33: 4.9 | 0.5 |
| | S43: 15.1 | |

Table 4 shows the values of parameters and the calculated values of the corresponding conditions of the lens structure of the third embodiment.

TABLE 4

| | | | |
|---|---|---|---|
| OT | 0.5, 1.0 | IT | 3.8 |
| LD | 5 | ID | 0.8 |
| OT/IT | 0.13, 0.26 | (OT × LD)/ID | 3.13, 6.25 |
| C_{cover}/C_{totC1} | 20%, 100% | Cₑₓₚₒₛₑ/C_{totC2} | 100% |

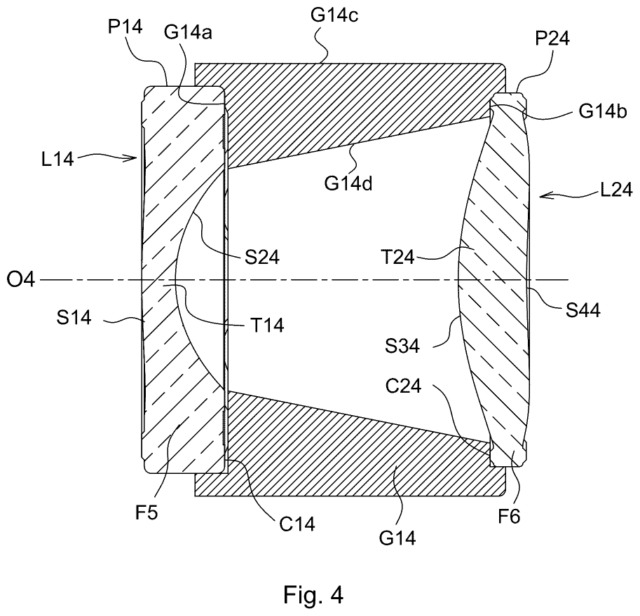

Referring to FIG. 4, a lens structure of a fourth embodiment of the invention includes a first lens L14, a first spacer G14 and a second lens L24 that are sequentially arranged along an optical axis O4.

In the fourth embodiment, the first lens L14 is a meniscus lens that includes a first surface S14, a second surface S24 disposed opposite to the first surface S14, and a first outer circumferential surface P14 disposed between the first surface S14 and the second surface S24 and parallel to the optical axis O4. The first surface S14 and the second surface S24 individually have an optical effective zone to form a first light transmitting portion T14 of the first lens L14. Further, the first surface S14 and the second surface S24 individually have a non-optical effective zone, wherein the non-optical effective zone of the second surface S24 forms a first joining portion C14 of the first lens L14. In the fourth embodiment, the first joining portion C14 is disposed on a side of a flange structure F5 that faces the first spacer G14, wherein the flange structure F5 is radially extended from the outer circumferential surface of the first light transmitting portion T14.

In the fourth embodiment, the second lens L24 is a meniscus lens that includes a third surface S34, a fourth surface S44 disposed opposite to the third surface S34, and a second outer circumferential surface P24 disposed between the third surface S34 and the fourth surface S44 and parallel to the optical axis O4. The third surface S34 and the fourth surface S44 individually have an optical effective zone to form a second light transmitting portion T24 of the second lens L24. Further, the third surface S34 and the fourth surface S44 individually have a non-optical effective zone, wherein the non-optical effective zone of the third surface S34 forms a second joining portion C24 of the second lens L24. In the fourth embodiment, the second joining portion C24 is disposed on a side of a flange structure F6 that faces the first spacer G14, wherein the flange structure F6 is radially extended from the outer circumferential surface of the second light transmitting portion T24.

The first spacer G14 includes two joining surfaces (namely a first end surface G14a and a second end surface G14b) disposed opposite to each other, and a first outer annular surface G14c and a first inner annular surface G14d disposed between the first end surface G14a and the second end surface G14b. The connection of the first lens L14, the first spacer G14 and the second lens L24 of the fourth embodiment is the same as that of the third embodiment, and therefore the descriptions thereof are omitted. The fourth embodiment differs from the third embodiment in that the first outer annular surface G14c of the first spacer G14 is disposed farther from the optical axis O4 than the first outer circumferential surface P14 of the first lens L14 and is also disposed farther from the optical axis O4 than the second outer circumferential surface P24 of the second lens L24. In the fourth embodiment, the first outer circumferential surface P14 is partially covered with the first spacer G14, so that the ratio of the exposed area of the first outer circumferential surface P14 that is not covered in the perpendicular axial direction to the total area of the first outer circumferential surface P14 is 70%. Similarly, the second outer circumferential surface P24 is partially covered with the first spacer G14, so that the ratio of the exposed area of the second outer circumferential surface P24 that is not covered in the perpendicular axial direction to the total area of the second outer circumferential surface P24 is 60%. The second surface S24 of the first lens L14 overlaps the first end surface G14a of the first spacer G14 in the optical axial direction O4, with about 100% of the first end surface G14a covered by the second surface S24 in the optical axial direction O4. That is, C_{cover}/C_{totC1} is about 100%. The third surface S34 of the second lens L24 overlaps the second end surface G14b of the first spacer G14 in the optical axial direction O4, with about 100% of the second end surface G14b covered by the third surface S34 in the optical axial direction O4. That is, C_{cover}/C_{totC1} is 100%. The spacer thickness of the fourth embodiment is not limited to that shown in Table 4 above and can be adjusted according to the requirements, such as but not limited to 0.1 mm to 50 mm. Under the same lens conditions, different lens structures with different optical properties such as different back focal length (BFL) or different field of view (FOV) can be obtained from combination of spacers of different thicknesses.

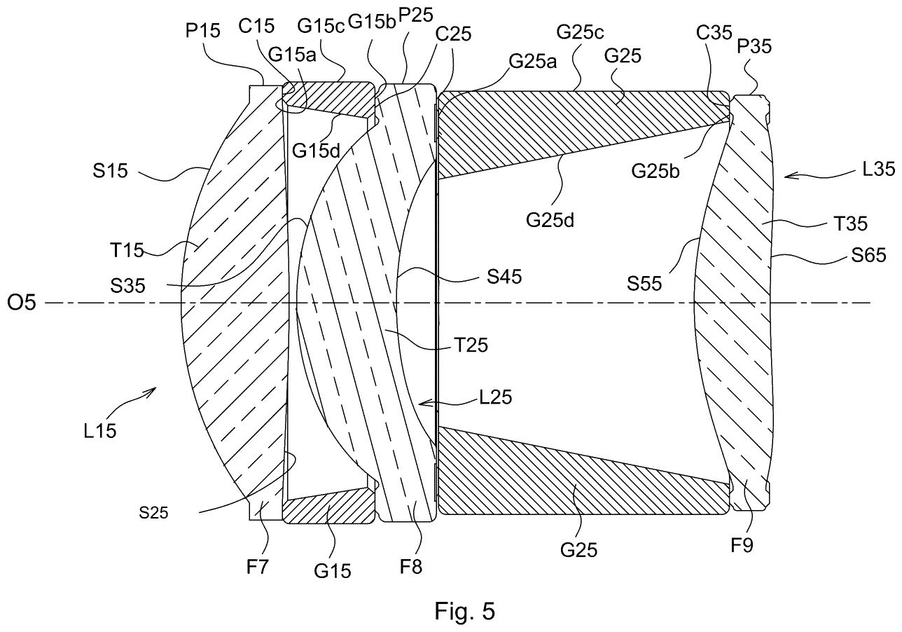

Referring to FIG. 5, a lens structure of a fifth embodiment of the invention includes a first lens L15, a first spacer G15, a second lens L25, a second spacer G25 and a third lens L35 that are sequentially arranged along an optical axis O5.

In the fifth embodiment, the first lens L15 is a biconvex lens that includes a first surface S15, a second surface S25 disposed opposite to the first surface S15, and a first outer circumferential surface P15 disposed between the first surface S15 and the second surface S25 and parallel to the optical axis O5. The first surface S15 and the second surface S25 individually have an optical effective zone to form a first light transmitting portion T15 of the first lens L15. Further, the first surface S15 and the second surface S25 individually have a non-optical effective zone, wherein the non-optical effective zone of the second surface S25 forms a first joining portion C15 of the first lens L15. In the fifth embodiment, the first joining portion C15 is disposed on a side of a flange structure F7 that faces the first spacer G15, wherein the flange structure F7 is radially extended from the outer circumferential surface of the first light transmitting portion T15.

In the fifth embodiment, the second lens L25 is a meniscus lens that includes a third surface S35, a fourth surface S45 disposed opposite to the third surface S35, and a second outer circumferential surface P25 disposed between the third surface S35 and the fourth surface S45 and parallel to the optical axis O5. The third surface S35 and the fourth surface S45 individually have an optical effective zone to form a second light transmitting portion T25 of the second lens L25. Further, the third surface S35 and the fourth surface S45 individually have a non-optical effective zone, wherein the non-optical effective zone forms a second joining portion C25 of the second lens L25. In the fifth embodiment, the second joining portion C25 includes a side of a flange structure F7 that faces the first spacer G15 and another side of the flange structure F7 that faces the second spacer G25, wherein the flange structure F7 is radially extended from the outer circumferential surface of the second light transmitting portion T25.

The first spacer G15 includes two joining surfaces (namely a first end surface G15a and a second end surface G15b) disposed opposite to each other, and a first outer annular surface G15c and a first inner annular surface G15d disposed between the first end surface G15a and the second end surface G15b. The connection of the first lens L15, the first spacer G15 and the second lens L25 of the fifth embodiment is the same as that of the third embodiment, and therefore the descriptions thereof are omitted. In the fifth embodiment, the first outer circumferential surface P15 is not covered with the first spacer G15, so that the ratio of the exposed area of the first outer circumferential surface P15 that is not covered in the perpendicular axial direction to the total area of the first outer circumferential surface P15 is 100%. Similarly, the second outer circumferential surface P25 is not covered with the first spacer G15, so that the ratio of the exposed area of the second outer circumferential surface P25 that is not covered in the perpendicular axial direction to the total area of the second outer circumferential surface P25 is 100%. The second surface S25 of the first lens L15 overlaps the first end surface G15a of the first spacer G15 in the optical axial direction O5, with about 25% of the first end surface G15a covered by the second surface S25 in the optical axial direction O5. That is, C_{cover}/C_{totC1} is about 25%. The third surface S35 of the second lens L25 overlaps the second end surface G15b of the first spacer G15 in the optical axial direction O5, with about 98% of the second end surface G15b covered by the third surface S35 in the optical axial direction O5. That is, C_{cover}/C_{totC1} is about 98%.

In the fifth embodiment, the third lens L35 is a meniscus lens that includes a fifth surface S55, a sixth surface S65 disposed opposite to the fifth surface S55, and a third outer circumferential surface P35 disposed between the fifth surface S55 and the sixth surface S65 and parallel to the optical axis O5. The fifth surface S55 and the sixth surface S65 individually have an optical effective zone to form a third light transmitting portion T35 of the third lens L35. Further, the fifth surface S55 and the sixth surface S65 individually have a non-optical effective zone, wherein the non-optical effective zone of the fifth surface S55 forms a third joining portion C35 of the third lens L35. In the fifth embodiment, the third joining portion C35 is disposed on a side of a flange structure F8 that faces the second spacer G25, wherein the flange structure F8 is radially extended from the outer circumferential surface of the third light transmitting portion T35.

The second spacer G25 includes two joining surfaces (namely a third end surface G25a and a fourth end surface G25b) disposed opposite to each other, and a second outer annular surface G25c and a second inner annular surface G25d disposed between the third end surface G25a and the fourth end surface G25b. The connection of the second lens L25, the second spacer G25 and the third lens L35 of the fifth embodiment is the same as that of the third embodiment, and therefore the descriptions thereof are omitted. In the fifth embodiment, the second outer circumferential surface P25 is not covered with the second spacer G25, so that the ratio of the exposed area of the second outer circumferential surface P25 that is not covered in the perpendicular axial direction to the total area of the second outer circumferential surface P25 is 100%. Similarly, the third outer circumferential surface P35 is not covered with the second spacer G25, so that the ratio of the exposed area of the third outer circumferential surface P35 that is not covered in the perpendicular axial direction to the total area of the third outer circumferential surface P35 is 100%. The fourth surface S45 of the second lens L25 overlaps the third end surface G25a of the second spacer G25 in the optical axial direction O5, with about 100% of the third end surface G25a covered by the fourth surface S45 in the optical axial direction O5. That is, C_{cover}/C_{totC1} is about 100%. The fifth surface S55 of the third lens L35 overlaps the fourth end surface G25b of the second spacer G25 in the optical axial direction O5, with about 75% of the fourth end surface G25b covered by the fifth surface S55 in the optical axial direction O5. That is, C_{cover}/C_{totC1} is about 75%.

Table 5 shows parameters of each elements of the lens structure of the fifth embodiment.

TABLE 5

| Element | Radius of Curvature (mm) | Thickness (mm) |
|---|---|---|
| L15 | S15: 4.2 | 1.5 |
| | S25: −20.9 | |
| G15 | — | 1.2 |
| L25 | S35: 3.3 | 1.4 |
| | S45: 4.8 | |
| G25 | — | 4.1 |
| L35 | S55: 4.8 | 0.9 |
| | S65: 13 | |

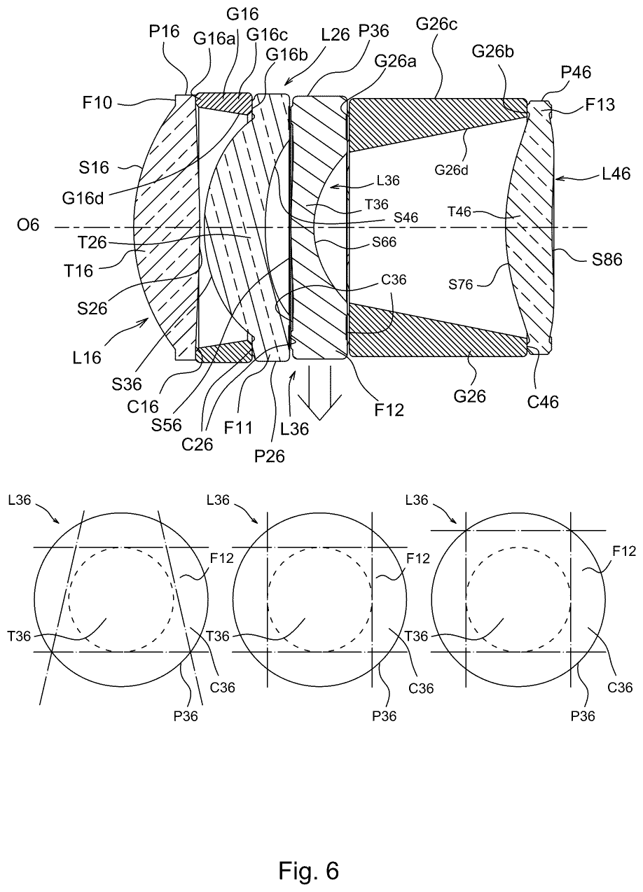

Referring to FIG. 6, a lens structure of a sixth embodiment of the invention includes a first lens L16, a first spacer G16, a second lens L26, a third lens L36, a second spacer G26 and a fourth lens L46 that are sequentially arranged along an optical axis O6.

In the sixth embodiment, the first lens L16 is a biconvex lens that includes a first surface S16, a second surface S26 disposed opposite to the first surface S16, and a first outer circumferential surface P16 disposed between the first surface S16 and the second surface S26 and parallel to the optical axis O6. The first surface S16 and the second surface S26 individually have an optical effective zone to form a first light transmitting portion T16 of the first lens L16. Further, the first surface S16 and the second surface S26 individually have a non-optical effective zone, wherein the non-optical effective zone of the second surface S26 forms a first joining portion C16 of the first lens L16. In the sixth embodiment, the first joining portion C16 is disposed on a side of a flange structure F10 that faces the first spacer G16, wherein the flange structure F10 is radially extended from the outer circumferential surface of the first light transmitting portion T16.

In the sixth embodiment, the second lens L26 is a meniscus lens that includes a third surface S36, a fourth surface S46 disposed opposite to the third surface S36, and a second outer circumferential surface P26 disposed between the third surface S36 and the fourth surface S46 and parallel to the optical axis O6. The third surface S36 and the fourth surface S46 individually have an optical effective zone to form a second light transmitting portion T26 of the second lens L26. Further, the third surface S36 and the fourth surface S46 individually have a non-optical effective zone, wherein the non-optical effective zone forms a second joining portion C26 of the second lens L26. In the sixth embodiment, the second joining portion C26 includes a side of a flange structure F11 that faces the first spacer G16 and another side of the flange structure F11 that faces the third lens L36, wherein the flange structure F11 is radially extended from the outer circumferential surface of the second light transmitting portion T26.

The first spacer G16 includes two joining surfaces (namely a first end surface G16a and a second end surface G16b) disposed opposite to each other, and a first outer annular surface G16c and a first inner annular surface G16d disposed between the first end surface G16a and the second end surface G16b. The connection of the first lens L16, the first spacer G16 and the second lens L26 of the sixth embodiment is the same as that of the third embodiment, and therefore the descriptions thereof are omitted.

In the sixth embodiment, the third lens L36 is a meniscus lens that includes a fifth surface S56, a sixth surface S66 disposed opposite to the fifth surface S56, and a third outer circumferential surface P36 disposed between the fifth surface S56 and the sixth surface S66 and parallel to the optical axis O6. The fifth surface S56 and the sixth surface S66 individually have an optical effective zone to form a third light transmitting portion T36 of the third lens L36. Further, the fifth surface S56 and the sixth surface S66 individually have a non-optical effective zone, wherein the non-optical effective zone forms a third joining portion C36 of the third lens L36. In the sixth embodiment, the third joining portion C36 includes a side of a flange structure F12 that faces the second spacer G26 and another side of the flange structure F12 that faces the second lens L26, wherein the flange structure F12 is radially extended from the outer circumferential surface of the third light transmitting portion T36.

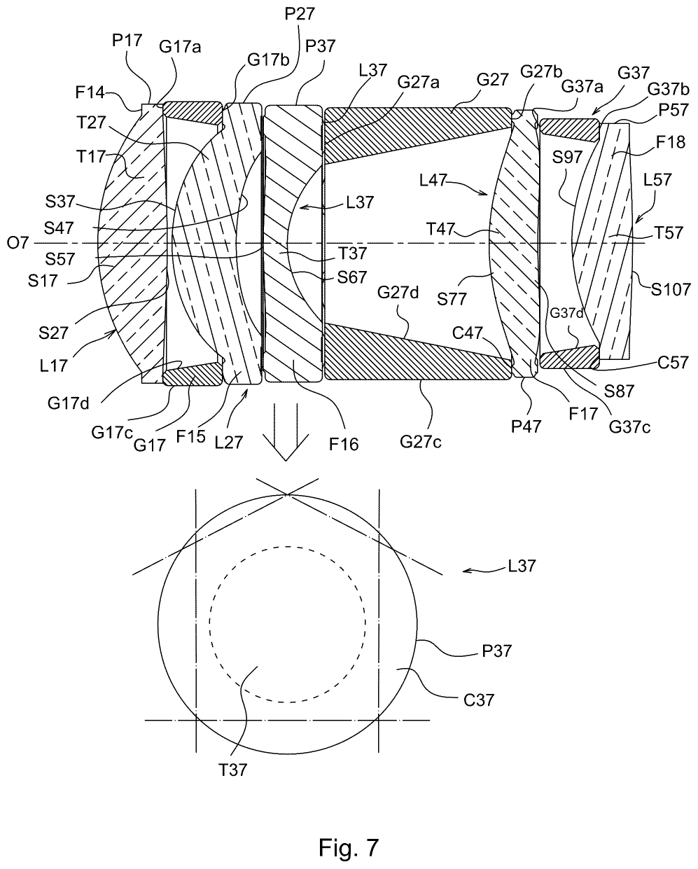

In the sixth embodiment, the second lens L26 and the third lens L36 are connected through two joining portions that face each other. The connection may be made by using, for example but not limited to, a laser welding process or adhesive bonding process, so that the two joining portions that face each other have no air gap therebetween. In some other embodiments, an additional spacer (not shown) may be provided between the second lens and the third lens. For example. basing on a seventh embodiment shown in FIG. 7 but without a third lens makes a fourth surface of a second lens to connect to a third end surface of a second spacer.

In the sixth embodiment, the fourth lens L46 is a meniscus lens that includes a seventh surface S76, an eighth surface S86 disposed opposite to the seventh surface S76, and a fourth outer circumferential surface P46 disposed between the seventh surface S76 and the eighth surface S86 and parallel to the optical axis O6. The seventh surface S76 and the eighth surface S86 individually have an optical effective zone to form a fourth light transmitting portion T46 of the fourth lens L46. Further, the seventh surface S76 and the eighth surface S86 individually have a non-optical effective zone, wherein the non-optical effective zone of the seventh surface S76 forms a fourth joining portion C46 of the fourth lens L46. In the sixth embodiment, the fourth joining portion C46 is disposed on a side of a flange structure F13 that faces the second spacer G26, wherein the flange structure F13 is radially extended from the outer circumferential surface of the fourth light transmitting portion T46.

The second spacer G26 includes two joining surfaces (namely a third end surface G26a and a fourth end surface G26b) disposed opposite to each other, and a second outer annular surface G26c and a second inner annular surface G26d disposed between the third end surface G26a and the fourth end surface G26b. The connection of the third lens L36, the second spacer G26 and the fourth lens L46 of the sixth embodiment is the same as that of the third embodiment, and therefore the descriptions thereof are omitted.

Table 6 shows parameters of each elements of the lens structure of the sixth embodiment.

TABLE 6

| Element | Radius of Curvature (mm) | Thickness (mm) |
|---|---|---|
| L16 | S16: 4.2 | 1.4 |
| | S26: −23.6 | |
| G16 | — | 1.3 |
| L26 | S36: 3.8 | 1.5 |
| | S46: 4.1 | |
| L36 | S56: 12.6 | 0.5 |
| | S66: 19.3 | |
| G26 | — | 4.1 |
| L46 | S76: 4.9 | 1.0 |
| | S86: 14.7 | |

Table 7 shows the values of parameters and the calculated values of the corresponding conditions of the lens structure of the sixth embodiment.

TABLE 7

| | | | |
|---|---|---|---|
| OT | 1.4, 1.5, 1 | IT | 1.3, 4.1 |
| LD | 4 | ID | 0.4 |
| OT/IT | 1.08, 0.34, 1.15, | (OT × LD)/ID | 14, 15, 10 |
| | 0.37, 0.77, 0.24 | | |
| C_{cover}/C_{totC1} | 75%, 100% | Cₑₓₚₒₛₑ/C_{totC2} | 100% |

The spacer thickness of the second embodiment is not limited to that shown in Table 7 above and can be adjusted according to the requirements, such as but not limited to 0.1 mm to 50 mm. Under the same lens conditions, different lens structures with different optical properties such as different back focal length (BFL) or different field of view (FOV) can be obtained by combining spacers of different thicknesses.

Referring to FIG. 7, a lens structure of a seventh embodiment of the invention includes a first lens L17, a first spacer G17, a second lens L27, a third lens L37, a second spacer G27, a fourth lens LA7, a third spacer G37 and a fifth lens L57 that are sequentially arranged along an optical axis O7.

The connection of the first lens L17, the first spacer G17, the second lens L27, the third lens L37, the second spacer G27 and the fourth lens L47 of the seventh embodiment is the same as that of the sixth embodiment, and therefore the descriptions thereof are omitted.

In the seventh embodiment, the third spacer G37 includes two joining surfaces (namely a fifth end surface G37a and a sixth end surface G37b) disposed opposite to each other, and a third outer annular surface G37c and a third inner annular surface G37d disposed between the fifth end surface G37a and the sixth end surface G37b.

The fifth lens L57 is a biconvex lens that includes a ninth surface S97, a tenth surface S107 disposed opposite to the ninth surface S97, and a fifth outer circumferential surface P57 disposed between the ninth surface S97 and the tenth surface S107 and parallel to the optical axis O7. The ninth surface S97 and the tenth surface S107 individually have an optical effective zone to form a fifth light transmitting portion T57 of the fifth lens L57. Further, the ninth surface S97 and the tenth surface S107 individually have a non-optical effective zone, wherein the non-optical effective zone of the ninth surface S97 forms a fifth joining portion C57 of the fifth lens L57. In the seventh embodiment, the fifth joining portion C57 is disposed on a side of a flange structure F18 that faces the third spacer G37, wherein the flange structure F18 is radially extended from the outer circumferential surface of the fifth light transmitting portion T57. The fifth joining portion C57 is connected to a sixth end surface G37b of the third spacer G37.

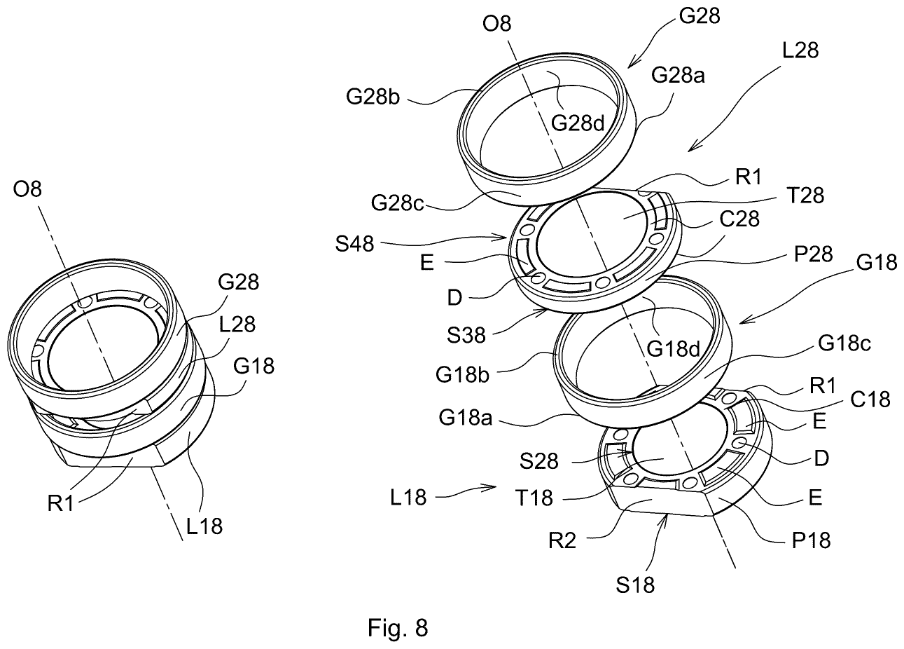

Referring to the lower part of FIG. 6 and the lower part of FIG. 7, the first lenses L16, L17, the second lenses L26, L27, the third lenses L36, L37, and the fourth lenses L46, L47 may be in shape of circle, oval, rectangle, polygon, trapezoid, or rectangle with four sides arranged asymmetrically relative to the optical axis. Alternatively, they may have the D-cut shape of the first lens L18 of FIG. 8 or the H-cut shape of the second lens L28 of FIG. 8. In the other embodiment the light transmitting portion could also be in shape of circle, oval, rectangle, polygon, trapezoid, rectangle, D-cut shape or H-cut shape. Taking the lower and the right part of FIG. 6 for an example, the third light transmitting portion T36 can be wider to near the third outer circumferential surface P36 so that the light transmitting portion could also be cut by the chain lines, or the chain lines could be near and overlapped with the light transmitting portion T36 so that be light transmitting portion could also be cut by the chain lines. In the other embodiment, the light transmitting portion can be wider to be between the dot line T36 and the solid line P36, so that the light transmitting portion could also be cut by the chain lines.

Table 8 shows parameters of each elements of the lens structure of the seventh embodiment.

TABLE 8

| Element | Radius of Curvature (mm) | Thickness (mm) |
|---|---|---|
| L17 | S17: 4.2 | 1.4 |
| | S17: −23.6 | |
| G17 | — | 1.3 |
| L27 | S37: 3.8 | 1.5 |
| | S47: 4.1 | |
| L37 | S57: 12.6 | 0.5 |
| | S67: 19.3 | |
| G27 | — | 4.4 |
| L47 | S77: 4.9 | 1.0 |
| | S87: 14.7 | |
| G37 | — | 1.2 |
| L57 | S97: 4.5 | 1.4 |
| | S107: −21.5 | |

Referring to FIG. 8, a lens structure of an eighth embodiment of the invention includes a first lens L18, a first spacer G18, a second lens L28 and a second spacer G28 that are sequentially arranged along an optical axis O8.

The first lens L18 includes a first surface S18, a second surface S28 disposed opposite to the first surface S18, and a first outer circumferential surface P18 disposed between the first surface S18 and the second surface S28 and parallel to the optical axis O8. The first surface S18 and the second surface S28 individually have an optical effective zone to form a first light transmitting portion T18 of the first lens L18. Further, the first surface S18 and the second surface S28 individually have a non-optical effective zone, wherein the non-optical effective zone of the second surface S28 forms a first joining portion C18 of the first lens L18. The first joining portion C18 has a plurality of rectangular protrusions E and a plurality of circular concave portions D. The protrusions E and the concave portions D are arranged circumferentially and alternately. The first lens L18 is an H-cut lens that has two tangential sections R1, R2.

The first spacer G18 includes two joining surfaces (namely a first end surface G18a and a second end surface G18b) disposed opposite to each other, and a first outer annular surface G18c and a first inner annular surface G18d disposed between the first end surface G18a and the second end surface G18b.

The second lens L28 includes a third surface S38, a fourth surface S48 disposed opposite to the third surface S38, and a second outer circumferential surface P28 disposed between the third surface S38 and the fourth surface S48 and parallel to the optical axis O8. The third surface S38 and the fourth surface S48 individually have an optical effective zone to form a second light transmitting portion T28 of the second lens L28. Further, the third surface S38 and the fourth surface S48 individually have a non-optical effective zone, wherein the non-optical effective zone forms a second joining portion C28 of the second lens L28. The second joining portion C28 has a plurality of rectangular protrusions E and a plurality of circular concave portions D. The protrusions E and the concave portions D are arranged circumferentially and alternately. The second lens L28 is a D-cut lens that has a tangential section R1.

The second spacer G28 includes two joining surfaces (namely a third end surface G28a and a fourth end surface G28b) disposed opposite to each other, and a second outer annular surface G28c and a second inner annular surface G28d disposed between the third end surface G28a and the fourth end surface G28b.

The first end surface G18a of the first spacer G18 is connected to the first joining portion C18 of the first lens L18. The second end surface G18b of the first spacer G18 is connected to a side of the second joining portion C28 of the second lens L28, and the third end surface G28a of the second spacer G28 is connected to another side of the second joining portion C28 of the second lens L28. The protrusions E and concave portions D of the first joining portion C18 and the second joining portion C28 are helpful to increase the strength of connection between the lenses and the spacers. The fourth end surface G28b may be connected to another lens, a display, a prism, a light guide, a protective glass, or an aperture stop (not shown). In the eighth embodiment, the spacers are annular. The protrusions E and concave portions D are not covered by the spacers in the perpendicular axial direction that is perpendicular to the optical axis O8.

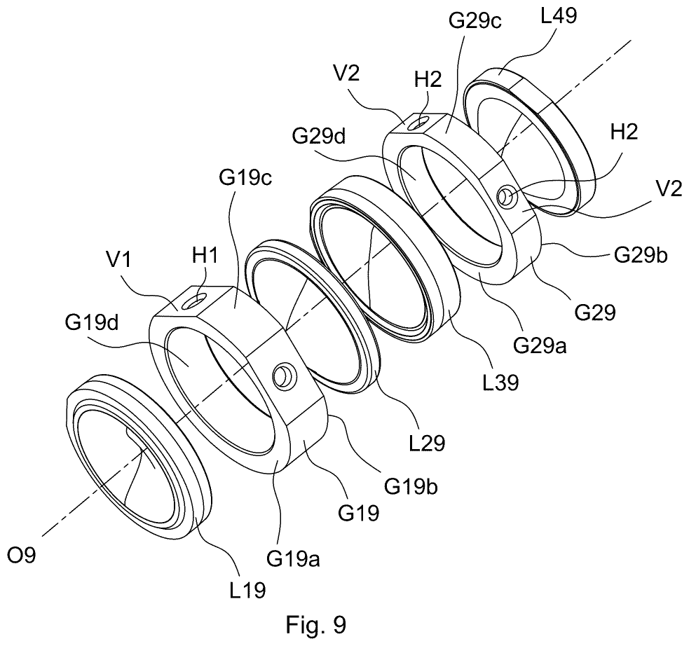

Referring to FIG. 9, a lens structure of a ninth embodiment of the invention includes a first lens L19, a first spacer G19, a second lens L29, a third lens L39, a second spacer G29 and a fourth lens L49 that are sequentially arranged along an optical axis O9. The connection of the first lens L19, the first spacer G19, the second lens L29, the third lens L39, the second spacer G29 and the fourth lens L49 of the ninth embodiment is the same as that of the sixth embodiment, and therefore the descriptions thereof are omitted. The second lens L29 and the third lens L39 may be connected through a spacer when it is required.

The following are the differences between the ninth embodiment and the eighth embodiment: In the ninth embodiment, the first spacer G19 has multiple chamfers V1 formed on the first outer annular surface G19c. The chamfers V1 substantially are tangential sections. Each chamfer V1 has a through hole H1 at the center. The through hole H1 is extended from the first outer annular surface G19c to the first inner annular surface G19d. The second spacer G29 has multiple chamfers V2 formed on the second outer annular surface G29c. The chamfers V2 substantially are tangential sections. Each chamfer V2 has a through hole H2 at the center. The through hole H2 is extended from the second outer annular surface G29c to the second inner annular surface G29d. The through holes are helpful for escape of gas from the lens structure that is generated by temperature change. Chamfers are helpful for control of precision of assembly and efficient use of space. In the ninth embodiment, the non-optical effective zone (namely the joining portion) of the lens is flat. The spacer is non-annular.

In some other embodiments (not shown), the first lens and the second lens may be the same in thickness. One of the first lens and the second lens may have the same radius of curvature as that in any one of the first embodiment through the seventh embodiment, and the other of the first lens and the second lens may be replaced with a prism. The values of parameters and the calculated values of the corresponding conditions of the lens structure are shown in Table 9.

TABLE 9

| | | | |
|---|---|---|---|
| OT | 4 | IT | 0.1 |
| LD | 20 | ID | 0.8 |
| OT/IT | 40 | (OT × LD)/ID | 100 |

Further, the spacer thickness is not limited to that shown in Table 9 above and can be adjusted according to the requirements, such as but not limited to 0.1 mm to 50 mm. Under the same lens conditions, different lens structures with different optical properties such as different back focal length (BFL) or different field of view (FOV) can be obtained by combining spacers of different thicknesses.

In the invention, the spacer of the eighth embodiment can be provided with the through holes of the ninth embodiment according to the requirements. The spacers of the first embodiment through the seventh embodiment can be replaced with the spacers of the eighth embodiment or the ninth embodiment. In the invention, the material of the lenses of the lens structure may be glass or plastic. The material of the spacers may be metal, glass or plastic.

In another embodiment, the lens structure not only has the same structure as any one of the above-mentioned embodiments but satisfies the condition 0.07≤OT/IT≤50 where OT is a thickness of any one of the lenses, and IT is a thickness of any one of the spacers. When the condition is satisfied, the lens structure has a reduced volume. In yet another embodiment, the lens structure not only has the same structure as any one of the above-mentioned embodiments but satisfies the condition 2.9 mm≤(OT×LD)/ID≤100 mm where OT is a thickness of any one of the lenses, LD is a diameter of any one of the lenses, and ID is a minimum sidewall thickness of any one of the spacers (the distance between an outer annular surface and a corresponding inner annular surface). When the condition is satisfied, the lens structure has a reduced volume. In still yet another embodiment, the lens structure not only has the same structure as any one of the above-mentioned embodiments but satisfies the condition 20%≤C_{cover}/C_{totC1}≤100% where C_{cover} is an area of a joining surface of any one of the spacers covered by a joining portion of an adjacent lens in an optical axial direction, and C_{totC1} is a total area of the joining surface of the spacer. When the condition is satisfied, the lens structure has increased strength. In further still another embodiment, the lens structure not only has the same structure as any one of the above-mentioned embodiments but satisfies the condition 50%≤Cₑₓₚₒₛₑ/C_{totC2}≤100% where Cₑₓₚₒₛₑ is an area of an outer circumferential surface of any one of the lenses that is exposed without being covered in the perpendicular axial direction, and C_{totC2} is a total area of the outer circumferential surface of the lens. When the condition is satisfied, the lens structure has increased strength.

When the lens structure of the invention is installed in micro-projectors, mobile phones, head-mounted displays or other products that require small lenses, any one of the lenses may have a central thickness ranged from 0.1 mm to 5 mm, any one of the spacers may have a thickness ranged from 0.1 mm to 50 mm, any one of the lenses may have a diameter ranged from 4 mm to 20 mm, and any one of the spacers may have a sidewall thickness ranged from 0.3 mm to 0.8 mm.

In the above-mentioned embodiments, the surface shape of each lens may be changed when it is required. For example, the first lens of the first embodiment that is a biconvex lens may be changed to a meniscus lens (concave-convex lens or convex-concave lens), a biconcave lens, a plano-concave lens, or a plano-convex lens. The same applies to other lenses of the first embodiments and all lenses of other embodiments. The surfaces of a lens and the adjacent lens that face each other may have the same radius of curvature or different radii of curvature. Any lenses of the first embodiment through the fifth embodiment may be changed to be in shape of rectangle, trapezoid, or rectangle with four sides arranged asymmetrically relative to the optical axis as shown in the lower part of FIG. 6 and shown with the chain lines, or in shape of polygon as shown in the lower part of FIG. 7 and shown with the chain lines, or to have the D-cut shape or H-cut shape of FIG. 8, or to be circular as shown in FIG. 9, or to be oval. In the above-mentioned embodiments, a diameter of any lens could be bigger, smaller or the same with an adjacent spacer. When a diameter of a lens is the same with an adjacent spacer, then the spacer could be overlapped with the spacer from the optical axis. But when the spacer comprises at least one chamfer disposed on the first outer annular surface of the spacer, then the lens would be exposed at the chamfer side of the spacer, and overlapped with the other side without chamfer of the spacer from the optical axis.

In the invention, the outer circumference (distant from the optical axis) of each lens and each spacer is not covered (no lens barrel is provided). Therefore, the lens structure of the invention has a reduced weight and a reduced volume.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention. Further, the terms “first” and “second” described in the specification and claims are only used to distinguish between different elements, embodiments or scopes, without limiting the quantity of the elements with an upper limit or a lower limit.

What is claimed is:

1. A lens structure, comprising:
an optical axis along which a light beam enters or exits from the lens structure;
a perpendicular axial direction which is perpendicular to the optical axis;
at least two lenses comprising a first lens and a second lens;
at least one spacer;
wherein the first lens comprises a first surface, a second surface disposed opposite to the first surface, and a first outer circumferential surface disposed between the first surface and the second surface;
wherein the second lens comprises a third surface, a fourth surface disposed opposite to the third surface, and a second outer circumferential surface disposed between the third surface and the fourth surface;
wherein the at least one spacer comprises a first spacer which comprises a first end surface, a second end surface disposed opposite to the first end surface, and a first outer annular surface disposed between the first end surface and the second end surface;
wherein the first end surface is connected to the second surface and the second end surface is connected to the third surface so that the first lens is connected to the second lens through the first spacer along the optical axis;
wherein the first outer circumferential surface, the second outer circumferential surface and the first outer annular surface are parallel to the optical axis;
wherein a projected area of the first outer annular surface projected onto the first outer circumferential surface in the perpendicular axial direction is 0%-50% of a total area of the first outer circumferential surface, and a projected area of the first outer annular surface projected onto the second outer circumferential surface in the perpendicular axial direction is 0%-50% of a total area of the second outer circumferential surface.

2. The lens structure as claimed in claim 1, wherein the first spacer further comprises a first inner annular surface and at least one through hole, the first inner annular surface and the first outer annular surface are disposed opposite to each other, the first inner annular surface is disposed between the first end surface and the second end surface and is disposed closer to the optical axis than the first outer annular surface, and the at least one through hole is extended from the first outer annular surface to the first inner annular surface;
wherein the first spacer further comprises at least one chamfer disposed on the first outer annular surface, the first lens further comprises a flange structure and a light transmitting portion, the light transmitting portion is radially extended to form the flange structure, and the flange structure is configured to bear the first spacer.

3. The lens structure as claimed in claim 1, wherein the first end surface and the second surface have no air gap therebetween; the second end surface and the third surface have no air gap therebetween; the first outer circumferential surface, the second outer circumferential surface and the first outer annular surface have a side disposed distant from the optical axis; the first lens, the second lens and the first spacer are exposed to an exterior of the lens structure at the side without being covered by a lens barrel.

4. The lens structure as claimed in claim 1, wherein the first lens or the second lens is circular, oval, rectangular, or polygonal, or has a D-cut shape or an H-cut shape.

5. The lens structure as claimed in claim 1, further comprising:
a third lens comprising a fifth surface, a sixth surface disposed opposite to the fifth surface, and a third outer circumferential surface disposed between the fifth surface and the sixth surface;
a fourth lens comprising a seventh surface, an eighth surface disposed opposite to the seventh surface, and a fourth outer circumferential surface disposed between the seventh surface and the eighth surface;
a second spacer comprising a third end surface, a fourth end surface disposed opposite to the third end surface, and a second outer annular surface disposed between the third end surface and the fourth end surface;
wherein the fourth surface is connected to the fifth surface, the third end surface and the sixth surface have no air gap therebetween, and the fourth end surface and the seventh surface have no air gap therebetween, so that the third lens is connected to the fourth lens through the second spacer along the optical axis;
wherein the third outer circumferential surface, the fourth outer circumferential surface and the second outer annular surface are parallel to the optical axis;
wherein the third outer circumferential surface, the fourth outer circumferential surface and the second outer annular surface have a side disposed distant from the optical axis;
wherein the third lens, the fourth lens and the second spacer are exposed to an exterior of the lens structure at the side without being covered by a lens barrel;
wherein the second outer circumferential surface and the third outer circumferential surface are not overlapped in the perpendicular axial direction.

6. The lens structure as claimed in claim 1, wherein the lens structure satisfies at least one of the following conditions:
$$0.07 ≦ OT / IT ≦ 50 ,$$
$$2.9 mm ≦ ( OT \times LD ) / ID ≦ 100 mm ,$$
$$20 \% ≦ {C}_{cover} / {C}_{totC 1} ≦ 100 \% ,$$
$$50 \% ≦ {C}_{expose} / {C}_{totC 2} ≦ 100 \% ,$$
where OT is a thickness of any one of the lenses, IT is a thickness of any one of the spacers, LD is a diameter of any one of the lenses, ID is a minimum sidewall thickness of any one of the spacers, C_{cover} is an area of a joining surface of any one of the spacers covered by a joining portion of an adjacent lens in an optical axial direction, C_{totC1} is a total area of the joining surface of the spacer, Cₑₓₚₒₛₑ is an area of an outer circumferential surface of any one of the lenses that is exposed 13 without being covered in the perpendicular axial direction, and C_{totC2} is a total area of the outer circumferential surface of the lens.

7. The lens structure as claimed in claim 1, wherein a surface of any one of the at least two lenses of the lens structure and an end surface of an adjacent spacer corresponding to the surface of any one of the at least two lenses are bonded, glued or fused to each other.

8. A lens structure, comprising:
an optical axis along which a light beam enters or exits from the lens structure;
a perpendicular axial direction which is perpendicular to the optical axis;
at least three lenses comprising a first lens, a second lens, and a third lens;
at least two spacers comprising a first spacer and a second spacer;
wherein the first lens comprises a first surface, a second surface disposed opposite to the first surface, and a first outer circumferential surface disposed between the first surface and the second surface;
wherein the second lens comprises a third surface, a fourth surface disposed opposite to the third surface, and a second outer circumferential surface disposed between the third surface and the fourth surface;
wherein the third lens comprises a fifth surface, a sixth surface disposed opposite to the fifth surface, and a third outer circumferential surface disposed between the fifth surface and the sixth surface;
wherein the first spacer comprises a first end surface, a second end surface disposed opposite to the first end surface, and a first outer annular surface disposed between the first end surface and the second end surface;
wherein the second spacer comprises a third end surface, a fourth end surface disposed opposite to the third end surface, and a second outer annular surface disposed between the third end surface and the fourth end surface;
wherein the first lens is connected to the second lens through the first spacer along the optical axis and the second lens is connected to the third lens through the second spacer along the optical axis;
wherein the first outer circumferential surface, the second outer circumferential surface, the third outer circumferential surface, the first outer annular surface and the second outer annular surface are parallel to the optical axis
wherein the second surface has a first radius of curvature at the optical axis, the third surface has a second radius of curvature at the optical axis, and the first radius of curvature is not equal to the second radius of curvature.

9. The lens structure as claimed in claim 8, wherein the first spacer further comprises a first inner annular surface and at least one through hole, the first inner annular surface and the first outer annular surface are disposed opposite to each other, the first inner annular surface is disposed between the first end surface and the second end surface and is disposed closer to the optical axis than the first outer annular surface, and the at least one through hole is extended from the first outer annular surface to the first inner annular surface;
wherein the first spacer further comprises at least one chamfer disposed on the first outer annular surface, the first lens further comprises a flange structure and a light transmitting portion, the light transmitting portion is radially extended to form the flange structure, and the flange structure is configured to bear the first spacer.

10. The lens structure as claimed in claim 8, wherein the first end surface and the second surface have no air gap therebetween; the second end surface and the third surface have no air gap therebetween; the third end surface and the fourth surface have no air gap therebetween, and the fourth end surface and the fifth surface have no air gap therebetween, the first outer circumferential surface, the second outer circumferential surface, the first outer annular surface and the second outer annular surface have a side disposed distant from the optical axis; the first lens, the second lens, the third lens, the first spacer and the second spacer are exposed to an exterior of the lens structure at the side without being covered by a lens barrel.

11. The lens structure as claimed in claim 8, wherein the first lens, second lens or the third lens is circular, oval, rectangular, or polygonal, or has a D-cut shape or an H-cut shape.

12. The lens structure as claimed in claim 8, further comprising:
a fourth lens comprising a seventh surface, an eighth surface disposed opposite to the seventh surface, and a fourth outer circumferential surface disposed between the seventh surface and the eighth surface;
a third spacer comprising a fifth end surface, a sixth end surface disposed opposite to the fifth end surface, and a third outer annular surface disposed between the fifth end surface and the sixth end surface;
wherein the fifth end surface and the sixth surface have no air gap therebetween, the sixth end surface and the seventh surface have no air gap therebetween, so that the third lens is connected to the fourth lens through the third spacer along the optical axis;
wherein the fourth outer circumferential surface and the third outer annular surface are parallel to the optical axis;
wherein the fourth outer circumferential surface and the third outer annular surface have a side disposed distant from the optical axis;
wherein the fourth lens and the third spacer are exposed to an exterior of the lens structure at the side without being covered by a lens barrel;
wherein the third outer circumferential surface and the fourth outer circumferential surface are not overlapped in the perpendicular axial direction.

13. The lens structure as claimed in claim 8, wherein the lens structure satisfies at least one of the following conditions:
$$0.07 ≦ OT / IT ≦ 50 ,$$
$$2.9 mm ≦ ( OT \times LD ) / ID ≦ 100 mm ,$$
$$20 \% ≦ {C}_{cover} / {C}_{totC 1} ≦ 100 \% ,$$
$$50 \% ≦ {C}_{expose} / {C}_{totC 2} ≦ 100 \% ,$$
where OT is a thickness of any one of the lenses, IT is a thickness of any one of the spacers, LD is a diameter of any one of the lenses, ID is a minimum sidewall thickness of any one of the spacers, C_{cover} is an area of a joining surface of any one of the spacers covered by a joining portion of an adjacent lens in an optical axial direction, C_{totC1} is a total area of the joining surface of the spacer, Cₑₓₚₒₛₑ is an area of an outer circumferential surface of any one of the lenses that is exposed without being covered in the perpendicular axial direction, and C_{totC2} is a total area of the outer circumferential surface of the lens.

14. The lens structure as claimed in claim 8, wherein a surface of any one of the at least two lenses of the lens structure and an end surface of an adjacent spacer corresponding to the surface of any one of the at least two lenses are bonded, glued or fused to each other.

15. A lens structure, comprising:
an optical axis along which a light beam enters or exits from the lens structure;
a perpendicular axial direction which is perpendicular to the optical axis;
at least three lenses comprising a first lens, a second lens, and a third lens;
at least two spacers comprising a first spacer and a second spacer;
wherein the first lens comprises a first surface, a second surface disposed opposite to the first surface, and a first outer circumferential surface disposed between the first surface and the second surface;
wherein the second lens comprises a third surface, a fourth surface disposed opposite to the third surface, and a second outer circumferential surface disposed between the third surface and the fourth surface;
wherein the third lens comprises a fifth surface, a sixth surface disposed opposite to the fifth surface, and a third outer circumferential surface disposed between the fifth surface and the sixth surface;
wherein the first spacer comprises a first end surface, a second end surface disposed opposite to the first end surface, and a first outer annular surface disposed between the first end surface and the second end surface;
wherein the second spacer comprises a third end surface, a fourth end surface disposed opposite to the third end surface, and a second outer annular surface disposed between the third end surface and the fourth end surface;
wherein the first end surface and the second surface have no air gap therebetween, the second end surface and the third surface have no air gap therebetween, the third end surface and the fourth surface have no air gap therebetween, and the fourth end surface and the fifth surface have no air gap therebetween, so that the first lens is connected to the second lens through the first spacer along the optical axis and the second lens is connected to the third lens through the second spacer along the optical axis;
wherein the first outer circumferential surface, the second outer circumferential surface, the third outer circumferential surface, the first outer annular surface and the second outer annular surface are parallel to the optical axis;
wherein the first outer circumferential surface, the second outer circumferential surface, the third outer circumferential surface, the first outer annular surface and the second outer annular surface have a side disposed distant from the optical axis;
wherein the first lens, the second lens, the third lens, the first spacer and the second spacer are not covered by a lens barrel at the side, are exposed to an exterior of the lens structure at the side, are directly in contact with air at the side, or are not covered by plastic material or metal material at the side.

16. The lens structure as claimed in claim 15, wherein the first spacer further comprises a first inner annular surface and at least one through hole, the first inner annular surface and the first outer annular surface are disposed opposite to each other, the first inner annular surface is disposed between the first end surface and the second end surface and is disposed closer to the optical axis than the first outer annular surface, and the at least one through hole is extended from the first outer annular surface to the first inner annular surface;
wherein the first spacer further comprises at least one chamfer disposed on the first outer annular surface, the first lens further comprises a flange structure and a light transmitting portion, the light transmitting portion is radially extended to form the flange structure, and the flange structure is configured to bear the first spacer.

17. The lens structure as claimed in claim 15, wherein the first lens, the second lens or the third lens is circular, oval, rectangular, or polygonal, or has a D-cut shape or an H-cut shape.

18. The lens structure as claimed in claim 15, wherein the lens structure satisfies at least one of the following conditions:
$$0.07 ≦ OT / IT ≦ 50 ,$$
$$2.9 mm ≦ ( OT \times LD ) / ID ≦ 100 mm ,$$
$$20 \% ≦ {C}_{cover} / {C}_{totC 1} ≦ 100 \% ,$$
$$50 \% ≦ {C}_{expose} / {C}_{totC 2} ≦ 100 \% ,$$
where OT is a thickness of any one of the lenses, IT is a thickness of any one of the spacers, LD is a diameter of any one of the lenses, ID is a minimum sidewall thickness of any one of the spacers, C_{cover} is an area of a joining surface of any one of the spacers covered by a joining portion of an adjacent lens in an optical axial direction, C_{totC1} is a total area of the joining surface of the spacer, Cₑₓₚₒₛₑ is an area of an outer circumferential surface of any one of the lenses that is exposed without being covered in the perpendicular axial direction, and C_{totC2} is a total area of the outer circumferential surface of the lens.

19. The lens structure as claimed in claim 15, wherein a surface of any one of the at least two lenses of the lens structure and an end surface of an adjacent spacer corresponding to the surface of any one of the at least two lenses are bonded, glued or fused to each other.

20. The lens structure as claimed in claim 15, wherein a projected area of the first outer annular surface projected onto the first outer circumferential surface in the perpendicular axial direction is 0%-50% of a total area of the first outer circumferential surface, and/or a projected area of the first outer annular surface projected onto the second outer circumferential surface in the perpendicular axial direction is 0%-50% of a total area of the second outer circumferential surface; and the second surface has a first radius of curvature at the optical axis, the third surface has a second radius of curvature at the optical axis, and the first radius of curvature is not equal to the second radius of curvature.
